(19) United States
(12) Patent Application Publication
(10) Pub. No.: US 2018/0287380 A1
(43) Pub. Date: Oct. 4, 2018

(54) EXTERNAL AND REDUNDANT POWER DEVICE AND POWER SYSTEM

(71) Applicants: HONG FU JIN PRECISION INDUSTRY (Shenzhen) CO., LTD., Shenzhen (CN); HON HAI PRECISION INDUSTRY CO., LTD., Shenzhen (CN)

(72) Inventors: YU-JEN LIN, New Taipei (TW); YI-GUO CHIU, New Taipei (TW)

(21) Appl. No.: 15/473,084

(22) Filed: Mar. 29, 2017

(51) Int. Cl. H02J 1/00; H02J 13/00; H02M 3/04; H02M 1/32; H04L 12/10

(52) U.S. Cl. CPC H02J 1/00; H02J 13/0003; H04L 12/10; H02M 1/32; H02M 3/04

(57) ABSTRACT

An external and redundant power device provides external electric powers and redundant electric powers. The external and redundant power device includes power supply units, a power integrated circuit, a power output control circuit and a controller. The power supply units provide input power streams. The power integrated circuit further integrates the input power to a whole power supply and converts a whole power supply first part into a first power. The power output control circuit acquires the whole power supply and respectively output preset power streams to the power receiving devices. The controller controls the power output control circuit outputting the preset power streams according to a whole power supply status and a connection condition.

### FIELD

The subject matter herein generally relates to a power supply, particularly relates to an external and redundant power device and a power system.

### BACKGROUND

External power sources are generally providing two types electric power streams. A first type power stream is used as a backup power stream. The first type power stream is generally called a Redundant Power Supply (RPS). It is configured to prevent a device shutting down from an inner power supply breaking down. A second type power stream is used as an external power stream. The second type power stream is generally called an External Power Supply (EPS). It is configured to provide additional power streams to Power Over Ethernet (POE) devices. Thus, the second type power stream can enhance power supplying capability in POE devices.

As a prior art, power devices are generally setting one power supply unit used as an RPS in one zone. However, these power devices only can supply a backup power stream to one power receiving device in its own zone. When more than one power supply is breaking down in its own zone, or when one or more power receiving devices are breaking down in other zones, they can't supply backup power streams to one more power receiving devices in its own zone. They can't supply backup power streams to one or more power receiving devices in other zones as well. Thus, power receiving devices can't acquire enough backup power streams to ensure powering safety. Furthermore, these power devices only can be used as an RPS or an EPS. These power devices can't provide the RPS and the EPS at the same time.

### SUMMARY

In one aspect of the disclosure, an external and redundant power device is configured to provide external electric power streams and redundant electric power streams. The external and redundant power device comprises a plurality of power supply units, a power integrated circuit, a power output control circuit and a controller. The external and redundant power device integrates a plurality of power supply units to be a whole power supply. The external and redundant power device can adjust power supplying according to the abnormal working of the power supply units and the power receiving devices. Thus, the external and redundant power device and the power system solve a problem that the prior art sets a plurality of zones failing to provide more electric power streams.

### BRIEF DESCRIPTION OF THE DRAWING

Implementations of the present technology will now be described, by way of example only, with reference to the attached figures, wherein:

FIG. 1 illustrates a diagrammatic view of an embodiment of an external and redundant power device and a power system.

FIG. 2 illustrates a diagrammatic view of an embodiment of an external and redundant power device and a power system.

FIG. 3 illustrates a diagrammatic view of an embodiment of an external and redundant power device and a power system.

FIG. 4 illustrates a diagrammatic view of an embodiment of an external and redundant power device and a power system.

FIG. 5 illustrates a diagrammatic view of an embodiment of an external and redundant power device and a power system.

FIG. 6 illustrates a diagrammatic view of an embodiment of an external and redundant power device and a power system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a power supply, particularly relates to an external and redundant power device and a power system. In the present disclose, the external and redundant power device and the power system are used to solve a problem that the prior art sets a plurality of zones to provide electric power. Thus, the external and redundant power device and a power system can take maximize full use available resources to provide electric power. In present disclosure, not only the external and redundant power device and a power system can independently provide the Redundant Power Supply (RPS), but also the external and redundant power device and a power system can independently provide the External Power Supply (EPS).

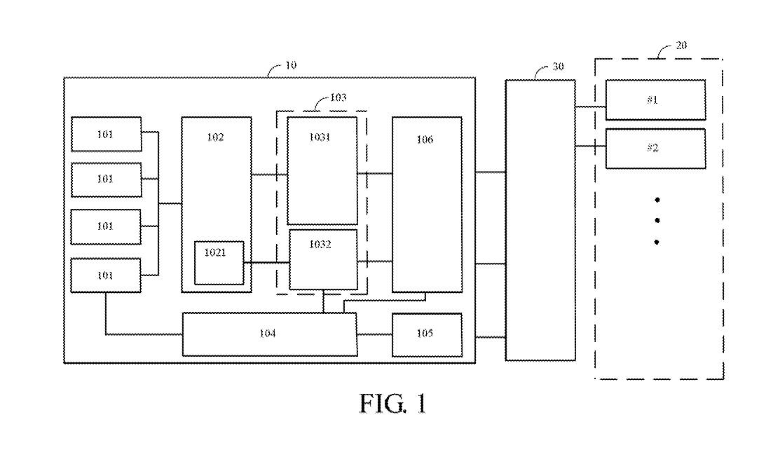

FIG. 1 illustrates a diagrammatic view of an embodiment of an external and redundant power device and a power system.

In at least one embodiment, an external and redundant power device 10 comprises a plurality of power supply units 101, a power integrated circuit 102, a power output control circuit 103 and a controller 104. A power system not only comprises the external and redundant power device 10 but also comprises a power receiving device 20 and power lines 30. The power receiving device 20 is configured to receive an external electric power stream and a backup power stream. The power lines 30 are configured to electrically couple the external and redundant power device and the power receiving device 20. In the embodiment, four power supply units 101 are illustrated.

As shown in FIG. 1, every power supply unit 101 is a power input device set in the external and redundant power device 10. All the power supply units 101 are electrically coupled to the power integrated circuit 102. Thus, the power integrated circuit 102 acquires all input power streams from every power supply unit 101. After acquiring the input power, the power integrated circuit 102 is configured to integrate the input power streams to a whole power supply. Finally, the power integrated circuit 102 converts a whole power supply first part into a first power stream P_{EPS}. The first power stream P_{EPS} is used as the EPS.

The power output control circuit 103 is electrically coupled to the power integrated circuit 102. Thus, the power output control circuit 103 can acquire the whole power supply and respectively output preset powers to a plurality of the power receiving devices 20.

The controller 104 is electrically coupled to the power integrated circuit 102 and the power output control circuit 103. The controller 104 is configured to control the power output control circuit 103 outputting the preset powers according to a whole power supply status and a connection condition the power receiving device 20 electrically coupled to the external and redundant power device 10.

In the embodiment, to accurately acquire power demand in the power receiving devices 20, the external and redundant power device 10 further comprises a detection circuit 105. The detection circuit 105 is electrically coupled between the controller 104 and output terminals in the external and redundant power device 10. When the power receiving devices 20 are electrically coupled to the output terminals in the external and redundant power device 10, the power demand in the power receiving devices 20 is feedback to the controller 104 through the detection circuit 105. Moreover, the detection circuit 105 can also send power consumption status to the power receiving device 20.

The external and redundant power device 10 further comprises a load monitoring circuit 106. The load monitoring circuit 106 is electrically coupled to the power output control circuit 103, the controller 104 and the output terminals in the external and redundant power device 10. The load monitoring circuit 106 is configured to monitor current consumption when the power output control circuit 103 outputs the preset powers. The load monitoring circuit 106 is configured to feedback corresponding control information to the controller 104. The corresponding control information is over current protection (OCP) information etc.

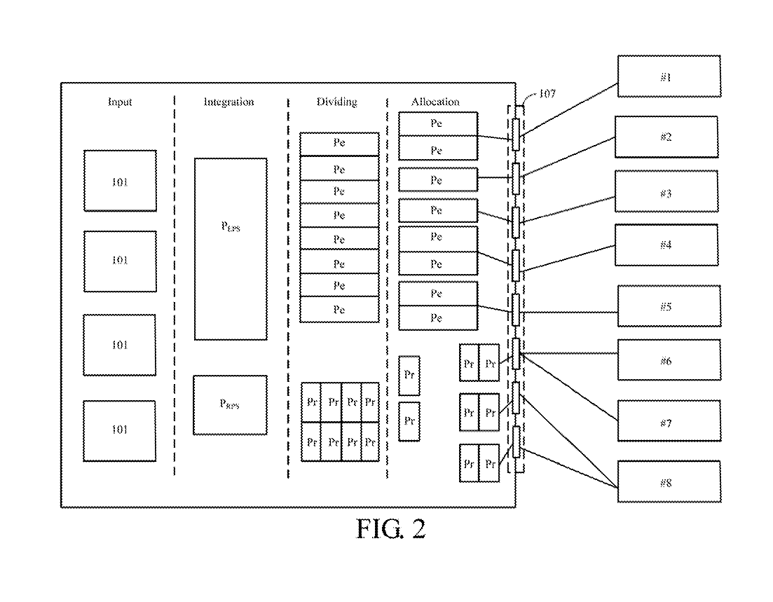

FIG. 2 illustrates a diagrammatic view of an embodiment of an external and redundant power device and a power system.

Base on the above embodiment, FIG. 2 illustrates how the external and redundant power device 10 and the power system process power.

Refer to FIG. 2, the external and redundant power device 10 also comprises four power supply units 101. Processing power streams in the external and redundant power device 10 and the power system mainly comprise a power inputting stage, a power integration stage, a power dividing stage, a power allocation stage and a power bonding stage.

In the power inputting stage, every power supply unit 101 is electrically coupled to the power integrated circuit 102. Thus, the power integrated circuit 102 acquires all input power stream from every power supply unit 101. After acquiring the input power, the power integrated circuit 102 is configured to integrate the input power streams to a whole power supply.

In the power integration stage, on the one hand, the power integrated circuit 102 converts a whole power supply first part into a first power stream P_{EPS}. On the other hand, the power integrated circuit 102 comprises the DC converter 1021. The DC converter 1021 is configured to convert a whole power supply second part into a second power stream P_{RPS}.

In the power dividing stage, the power output control circuit 103 comprises the external power dividing circuit 1031 and the redundant power dividing circuit 1032. The external power dividing circuit 1031 is configured to equally divide the first power stream P_{EPS} into a plurality of external electric power streams Pe. The redundant power dividing circuit 1032 is configured to equally divide the second power stream P_{RPS} into a plurality of redundant electric powers Pr.

In the embodiment, as shown in FIG. 2, according to a whole power supply status and a connection condition the power receiving devices 20 electrically coupled to the external and redundant power device 10, the controller 104 controls the power output control circuit 103 to divide the first power stream P_{EPS} into eight external electric power streams Pe. The eight external electric power streams Pe are with a same power rate. The controller 104 controls the power output control circuit 103 to divide the second power stream P_{RPS} into eight redundant electric power streams Pr. According to a connection condition that the power receiving devices 20 electrically coupled to the external and redundant power device 10, the controller 104 calculates available output power budget in the external and redundant power device 10. The controller 104 then allocates the eight external electric power streams Pe and the eight redundant electric power streams Pr. In addition, according to power consumption in the power receiving device 20, the controller 104 further adjusts quantity and power rate of the external electric power streams Pe and the redundant electric power streams Pr.

In the power allocation stage, to legitimately allocating power, the controller 104 acquire power demand in the power receiving devices 20 and available power quantity of the external electric power stream Pe and the redundant electric power stream Pr through the detection circuit 105.

In the power bonding stage, according to the power demand, in the control of the controller 104, the power output control circuit 103 allocates one or two external electric power streams Pe to a same power output terminal 107. Thus, one power output terminal 107 can output one or two external electric power streams Pe to the power receiving device 20. According to the power demand, in the control of the controller 104, the power output control circuit 103 allocates one or two redundant electric power stream Pr to a same power output terminal 107. Thus, one power output terminal 107 can output one or two redundant electric power streams Pr to the power receiving device 20.

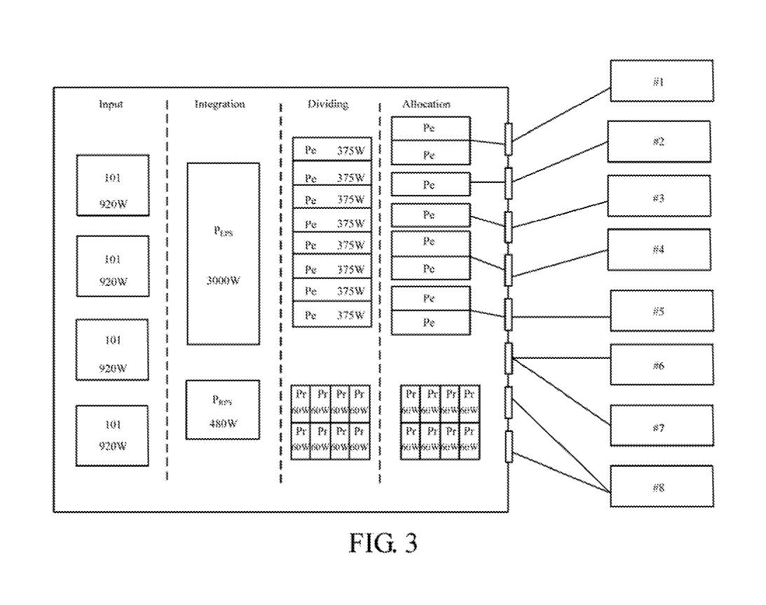

Detailed execution of the power allocation stage and the power bonding stage, please refer to FIG. 3. FIG. 3 illustrates a diagrammatic view of an embodiment of an external and redundant power device and a power system. As shown in FIG. 3, there are four power supply units 101 of 920 watts (W) power rate in the embodiment.

In the power inputting stage, total input power stream is total power streams of the four power supply units 101. The total input power stream is 3680 W. To avoid exhaust all the input power stream in the external and redundant power device 10. The power integrated circuit 102 only integrates 3480 W as a whole power supply. The first power stream P_{EPS} is 3000 W. The second power stream P_{RPS} is 480 W.

In at least one embodiment, to receive more power, one power receiving device 20 can be electrically coupled to two power output terminals 107 through two power lines 30. To raise quantity that the power receiving devices 20 electrically coupled to the external and redundant power device 10, one power output terminal 107 can be electrically coupled to two power receiving devices 20.

As shown in FIG. 3, the external and redundant power device 10 is electrically coupled to eight power receiving devices 20. The first to the fifth power receiving devices (#1-#5) are Power Over Ethernet (POE) devices. Each of the first to the fifth power receiving devices (#1-#5) is electrically coupled to one power output terminal 107 through one power line 30. To raise quantity that the power receiving devices 20 electrically coupled to the external and redundant power device 10, the sixth power receiving device #6 and the seventh power receiving device #7 are electrically coupled to a same power output terminal 107 respectively through one power line 30. To receive more power, the eighth power receiving device #8 is electrically coupled to two power output terminals 107 through two power lines 30.

The power demand in the power receiving devices 20 is feedback to the controller 104 through the detection circuit 105. In the power dividing stage, in the control of the controller 104, the external power dividing circuit 1031 equally divides the first power stream P_{EPS} into eight external electric power streams Pe. Each external electric power stream Pe is 375 W. The redundant power dividing circuit 1032 equally divides the second power stream P_{RPS} into eight redundant electric powers Pr. Each redundant electric power stream Pr is 60 W.

In at least one embodiment, the powers that the first to the eighth power receiving devices (#1-#8) themselves needed are 120 W, 60 W, 60 W, 120 W, 120 W, 60 W, 60 W, 240 W. When one power receiving device 20 is working normally, the power receiving device 20 uses its inner power supply to provide power streams. Until its inner power supply can't provide power, the redundant electric power stream Pr provides power stream to the power receiving device 20. Therefore, in the embodiment, the power receiving devices 20 are working normally, the power receiving devices 20 use its inner power supply to provide power streams. The controller 104 only needs to allocate the external electric power streams Pe. As shown in FIG. 3, the first power receiving device #1, the fourth power receiving device #4 and the fifth power receiving device #5 all receive two external electric power streams Pe. The second power receiving device and the third power receiving device #3 both receive one external electric power stream Pe. The redundant electric powers Pr are not allocated.

In at least one embodiment, the powers that the sixth to seventh power receiving devices (#6-#7) needed are both 60 W. The sixth to the seventh power receiving devices (#6-#7) are electrically coupled to a sixth power output terminal 107 in the external and redundant power device 10. When one inner power supply in the sixth power receiving device #6 or the seventh power receiving device #7 can't provide a power stream, the external and redundant power device 10 allocates one redundant electric power stream Pr to the sixth power output terminal 107. Thus, the redundant electric power stream Pr in the sixth power output terminal 107 could be a backup power stream for the sixth power receiving device #6 or the seventh power receiving device #7. When all inner power supplies in the sixth power receiving device #6 and the seventh power receiving device #7 can't provide power streams, the external and redundant power device 10 allocates two redundant electric power streams Pr to the sixth power output terminal 107. Thus, the redundant electric power streams Pr in the sixth power output terminal 107 could be backup power streams for the sixth power receiving device #6 and the seventh power receiving device #7.

The eighth power receiving device #8 is electrically coupled to a seventh power output terminal 107 and an eighth power output terminal 107 in the external and redundant power device 10. The external and redundant power device 10 allocates two redundant electric power streams Pr to the seventh power output terminal 107. The external and redundant power device 10 further allocates two redundant electric power streams Pr to the eighth power output terminal 107. Thus, when the inner power supply in the eighth power receiving device #8 can't provide a power stream, the seventh power output terminal 107 and the eighth power output terminal 107 both provide power streams to the eighth power receiving device #8.

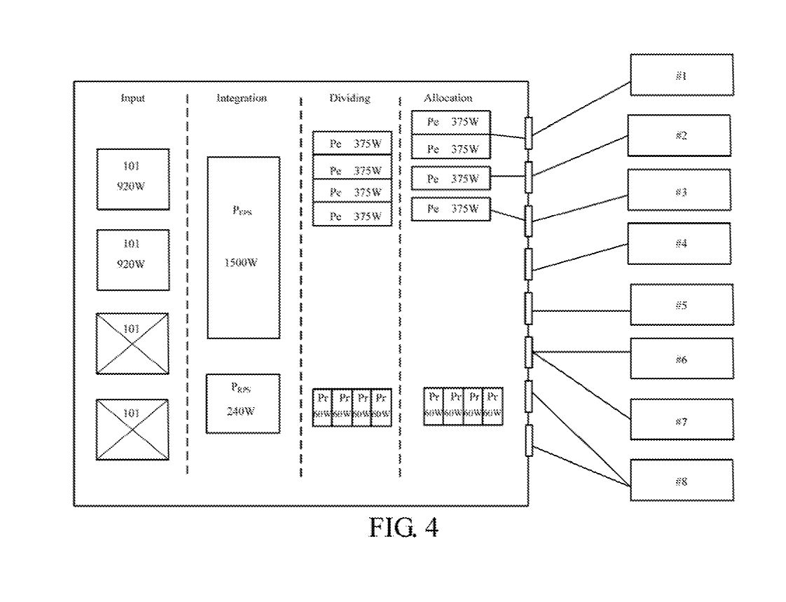

FIG. 4 illustrates a diagrammatic view of an embodiment of an external and redundant power device and a power system.

In the embodiment, the external and redundant power device 10 is electrically coupled to the power receiving devices 20 as the same connection shown in the above embodiment. The difference is that two power supply units 101 can't input power streams in the external and redundant power device 10.

In the power inputting stage, total input power stream is total power streams of the two power supply units 101. The total input power is 1840 W. To avoid exhaust all the input power streams in the external and redundant power device 10. The power integrated circuit 102 only integrates 1740 W as a whole power supply. The first power stream P_{EPS} is 1500 W. The second power stream P_{RPS} is 240 W.

In the power dividing stage, in the control of the controller 104, the external power dividing circuit 1031 equally divides the first power streams P_{EPS} into four external electric power streams Pe. Each external electric power stream Pe is 375 W. The redundant power dividing circuit 1032 equally divides the second power stream P_{RPS} into four redundant electric power streams Pr. Each redundant electric power stream Pr is 60 W.

In at least one embodiment, according to power consumption in the power receiving device 20, the controller 104 allocates the external electric power streams Pe. There are only four external electric power streams Pe, the controller 104 allocates the external electric power streams Pe according to a priority in the power receiving devices 20. The first power receiving device #1 has the highest priority. The eighth power receiving device #8 has the lowest priority. As shown in FIG. 4, the first power receiving device #1 receives two external electric power streams Pe. The second power receiving device #2 and the third power receiving device #3 both receive one external electric power stream Pe. Thus, all the external electric power streams Pe have been allocated. Neither the fourth power receiving device #4 nor the fifth power receiving device #5 receives the external electric power stream Pe. All the power receiving devices 20 are working normally, the redundant electric power streams Pr haven't been allocated. If any inner power supplies in the power receiving devices 20 can't provide power streams, the redundant electric powers Pr still can be allocated to the power receiving device 20.

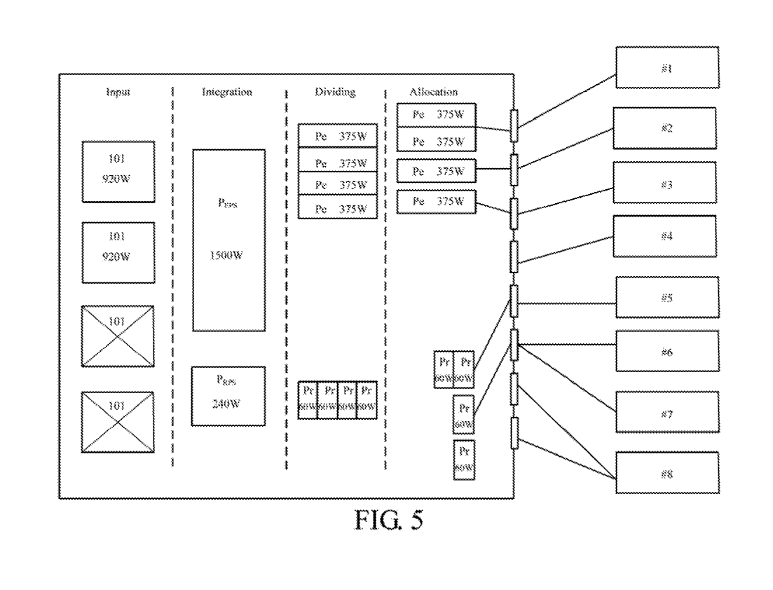

FIG. 5 illustrates a diagrammatic view of an embodiment of an external and redundant power device and a power system.

In the embodiment, the external and redundant power device 10 is electrically coupled to the power receiving devices 20 as the same connection shown in the above embodiment. The difference is that two power supply units 101 can't input power in the external and redundant power device 10.

In the power inputting stage, total input power stream is total power streams of the four power supply units 101. The total input power is 1840 W. To avoid exhaust all the input power in the external and redundant power device 10. The power integrated circuit 102 only integrates 1740 W as a whole power supply. The first power stream P_{EPS} is 1500 W. The second power stream P_{RPS} is 240 W.

In the power dividing stage, in the control of the controller 104, the external power dividing circuit 1031 equally divides the first power stream P_{EPS} into four external electric power streams Pe. Each external electric power stream Pe is 375 W. The redundant power dividing circuit 1032 equally divides the second power stream P_{RPS} into four redundant electric power streams Pr. Each redundant electric power stream Pr is 60 W.

In the embodiment, the powers that the first to the eighth power receiving devices (#1-#8) themselves needed are 120 W, 60 W, 60 W, 120 W, 120 W, 60 W, 60 W, 240 W. All the power receiving devices 20 are working normally except the fifth power receiving device #5 and the sixth power receiving device #6. Inner power supplies in the fifth power receiving device #5 and the sixth power receiving device #6 can't provide power streams. According to power consumption in the power receiving device 20, the controller 104 allocates the external electric power streams Pe and the redundant electric power streams Pr. There are only four external electric power streams Pe, the controller 104 still allocates the external electric power streams Pe according to the priority in the power receiving devices 20.

As shown in FIG. 4, the first power receiving device #1 receives two external electric power streams Pe. The second power receiving device #2 and the third power receiving device #3 both receive one external electric power stream Pe. Thus, all the external electric power streams Pe have been allocated. Neither the fourth power receiving device #4 nor the fifth power receiving device #5 receives the external electric power stream Pe.

The inner power supplies in the fifth power receiving device #5 and the sixth power receiving device #6 can't provide power streams. The controller 104 allocates two redundant electric power streams Pr to the fifth power receiving device #5. The controller 104 also allocates one redundant electric power stream Pr to the sixth power receiving device #6. Thus, remaining one redundant electric power stream Pr that has not been allocated. If any inner power supply in the power receiving devices 20 can't provide power, the redundant electric power stream Pr still can be allocated to the power receiving device 20.

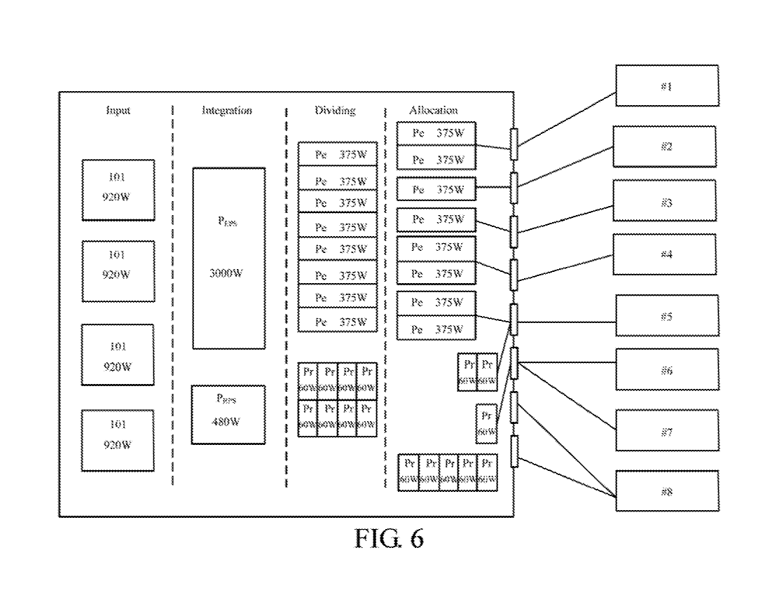

FIG. 6 illustrates a diagrammatic view of an embodiment of an external and redundant power device and a power system.

In the embodiment, the external and redundant power device 10 is electrically coupled to the power receiving devices 20 as the same connection shown in the above embodiment. The difference is that four power supply units 101 can input power in the external and redundant power device 10 now. All the power receiving devices 20 are working normally except the fifth power receiving device #5 and the sixth power receiving device #6. Inner power supplies in the fifth power receiving device #5 and the sixth power receiving device #6 can't provide power streams.

In the power integration stage, total input power is a total power stream of the four power supply units 101. The total input power stream is 3680 W. To avoid exhaust all the input power in the external and redundant power device 10. The power integrated circuit 102 only integrates 3480 W as a whole power supply. The first power stream P_{EPS} is 3000 W. The second power stream P_{RPS} is 480 W.

In the power dividing stage, in the control of the controller 104, the external power dividing circuit 1031 equally divides the first power stream P_{EPS} into eight external electric power streams Pe. Each external electric power stream Pe is 375 W. The redundant power dividing circuit 1032 equally divides the second power stream Pₘₛ into eight redundant electric power streams Pr. Each redundant electric power stream Pr is 60 W.

In at least one embodiment, the powers that the first to the eighth power receiving devices (#1-#8) themselves needed are 120 W, 60 W, 60 W, 120 W, 120 W, 60 W, 60 W, 240 W. The inner power supplies in the fifth power receiving device #5 and the sixth power receiving device #6 can't provide power streams. The controller 104 allocates two redundant electric power streams Pr to the fifth power receiving device #5. The controller 104 also allocates one redundant electric power stream Pr to the sixth power receiving device #6. Thus, remaining five redundant electric power streams Pr that have not been allocated. If any inner power supply in the power receiving devices 20 can't provide power streams, the redundant electric power streams Pr still can be allocated to the power receiving device 20.

In at least one embodiment, according to power consumption in the power receiving device 20, the controller 104 allocates the external electric power streams Pe. There are eight external electric power streams Pe to be allocated. As shown in FIG. 6, the first power receiving device #1, the fourth power receiving device #4 and the fifth power receiving device #5 all receive two external electric power streams Pe. The second power receiving device and the third power receiving device #3 both receive one external electric power stream Pe.

In the present disclosure, the external and redundant power device 10 and power system integrate a plurality of power supply units 101 to be a whole power supply. The external and redundant power device 10 and power system can adjust power supplying according to the abnormal working in the power supply units 101 and the power receiving devices 20. Thus, the external and redundant power device 10 and the power system solve a problem that the prior art sets a plurality of zones failing to provide more electric power streams.

Many details are often found in art including other features of the regulating circuit and the optimizing circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. An external and redundant power device, configured to provide external electric power streams and redundant electric power streams, comprising:
a plurality of power supply units configured to provide input power streams in the external and redundant power device;
a power integrated circuit electrically coupled to the plurality of power supply units, configured to acquire all the input power streams from the plurality of power supply units, wherein the power integrated circuit further is configured to integrate the input power streams to a whole power supply and convert a whole power supply first part into a first power;
a power output control circuit electrically coupled to the power integrated circuit, configured to acquire the whole power supply and respectively output preset power streams to a plurality of power receiving devices; and
a controller electrically coupled to the power integrated circuit and the power output control circuit, configured to control the power output control circuit outputting the preset power streams according to a whole power supply status and a connection condition that the plurality of power receiving devices electrically coupled to the external and redundant power device.

2. The external and redundant power device as claimed in claim 1, further comprising a load monitoring circuit, wherein the load monitoring circuit is electrically coupled to the power output control circuit, the controller and power output terminals in the external and redundant power device; the load monitoring circuit is configured to monitor current consumption when the power output control circuit is outputting the preset power streams; and the load monitoring circuit is further configured to feed back over current protection (OCP) information to the controller.

3. The external and redundant power device as claimed in claim 1, further comprising a detection circuit electrically coupled between the controller and power output terminals in the external and redundant power device, wherein the detection circuit is configured to feed back power demands of the plurality of power receiving devices to the controller.

4. The external and redundant power device as claimed in claim 3, wherein the power integrated circuit comprises a DC converter, and the DC converter is configured to convert a whole power supply second part into a second power.

5. The external and redundant power device as claimed in claim 4, wherein the power output control circuit comprises a redundant power dividing circuit, and the redundant power dividing circuit is configured to equally divide a second power stream into a plurality of the redundant electric powers in a same power rate.

6. The external and redundant power device as claimed in claim 5, wherein the controller is configured to control the power output control circuit to allocate one or two redundant electric power streams to one power output terminal according to the power demands.

7. The external and redundant power device as claimed in claim 1, wherein the power output control circuit comprises an external power dividing circuit, and the external power dividing circuit is configured to equally divide a first power stream into a plurality of the external electric power streams in a same power rate.

8. The external and redundant power device as claimed in claim 7, wherein the controller is configured to control the power output control circuit to allocate one or two external electric power streams to one power output terminal according to power demands.

9. A power system comprising:
An external and redundant power device, configured to provide external electric power streams and redundant electric power streams;
a plurality of power receiving devices, configured to receive the external electric power streams and the redundant electric power streams; and
a plurality of power lines, electrically coupled between the external and redundant power device and the plurality of power receiving devices;
wherein the external and redundant power device comprises:
a plurality of power supply units configured to provide input power streams in the external and redundant power device;
a power integrated circuit electrically coupled to the plurality of power supply units, configured to acquire all the input power streams from the plurality of power supply units, wherein the power integrated circuit further configured to integrate the input power streams to a whole power supply and convert a whole power supply first part into a first power;
a power output control circuit electrically coupled to the power integrated circuit, configured to acquire the whole power supply and respectively output preset power streams to a plurality of power receiving devices; and
a controller electrically coupled to the power integrated circuit and the power output control circuit, configured to control the power output control circuit outputting the preset power streams according to a whole power supply status and a connection condition that the plurality of power receiving devices electrically coupled to the external and redundant power device.

10. The power system as claimed in claim 9, further comprising a load monitoring circuit, wherein the load monitoring circuit is electrically coupled to the power output control circuit, the controller and power output terminals in the external and redundant power device; the load monitoring circuit is configured to monitor current consumption when the power output control circuit is outputting the preset power streams; and the load monitoring circuit is further configured to feed back over current protection (OCP) information to the controller.

11. The power system as claimed in claim 9, further comprising a detection circuit electrically coupled between the controller and power output terminals in the external and redundant power device, wherein the detection circuit is configured to feed back power demands in the plurality of power receiving devices to the controller.

12. The power system as claimed in claim 11, wherein the power integrated circuit comprises a DC converter; the DC converter is configured to convert a whole power supply second part into a second power.

13. The power system as claimed in claim 12, wherein the power output control circuit comprises a redundant power dividing circuit; the redundant power dividing circuit is configured to equally divide the second power into a plurality of the redundant electric power streams in a same power rate.

14. The power system as claimed in claim 13, wherein the controller is configured to control the power output control circuit to allocate one or two redundant electric power streams to one power output terminal according to the power demands.

15. The power system as claimed in claim 9, wherein the power output control circuit comprises an external power dividing circuit, and the external power dividing circuit is configured to equally divide a first power stream into a plurality of the external electric power streams in a same power rate.

16. The power system as claimed in claim 15, wherein the controller is configured to control the power output control circuit to allocate one or two external electric power streams to one power output terminal according to power demands.
